(19) United States
(12) Patent Application Publication
(10) Pub. No.: US 2013/0166931 A1
(43) Pub. Date: Jun. 27, 2013

(54) REDUCING POWER CONSUMPTION OF MEMORY

(71) Applicants: Ruggero Castagnetti, Menlo Park, CA (US); Ting Zhou, Orinda, CA (US); Ramnath Venkatraman, San Jose, CA (US)

(72) Inventors: Ruggero Castagnetti, Menlo Park, CA (US); Ting Zhou, Orinda, CA (US); Ramnath Venkatraman, San Jose, CA (US)

(73) Assignee: LSI Corporation

(21) Appl. No.: 13/336,826

(22) Filed: Dec. 23, 2011

(51) Int. Cl. G06F 1/32

(52) U.S. Cl. 713/322

(57) ABSTRACT

Described embodiments provide for a memory system which power-gates a memory operating at a first clock. Control logic in the memory system activates, during a rising edge of a second clock, the memory from a sleep mode. The memory is accessed. After a cycle of the first clock, the control logic asserts a power-gating signal, thereby returning the memory to the sleep mode. The frequency of the second clock is less than a frequency of the first clock.

### CROSS-REFERENCE TO RELATED APPLICATIONS

The subject matter of this application is related to U.S. patent application Ser. Nos. 13/XXX,XXX filed Dec. XX, 2011 as attorney docket no. L11-0023US1, and 13/XXX,XXX filed Dec. XX, 2011 as attorney docket no. L11-0071US1, the teachings of all of which are incorporated herein in their entireties by reference.

### BACKGROUND OF THE INVENTION

1. Field of the Invention

The present invention relates to memory, in particular, to reducing a memory device's power consumption.

2. Description of the Related Art

Memory is a significant consumer of power in typical processing systems. Often the same memory solution is required to operate at a wide frequency range within the same application or in multiple applications. Typical memory designed for a high-speed application incurs a significant static power component. The static power component refers to power required to power the memory when idle so that the memory's data is not lost. Static power drives the minimum power consumption “floor” of the memory. Memory performance also varies across process corners, voltages, and temperatures (PVT). Generally memory performance is slowest in slow silicon and low voltage, but memory power leakage is lowest with slow silicon and low voltage. Memory power leakage is generally highest with fast silicon, high voltage, and high temperature.

Power management strategies might reduce memory power consumption. Conventional memory power-gating does not account for PVT, and often requires changes to a system-on-chip (SOC) in order to take advantage of power-gating signals. Power consumption might be reduced by reducing the operating frequency of the memory until dynamic power equals static power. While this solution reduces power consumption, the solution does not result in significant power savings for the corresponding reduction in the operating frequency range of the memory.

Transparent source bias (TSB) might also be incorporated in memory array circuitry to reduce power leakage, but TSB reduces the speed of a memory circuit.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Described embodiments provide for a memory system which power-gates a memory operating at a first clock. Control logic in the memory system activates, during a rising edge of a second clock, the memory from a sleep mode. The memory is accessed. After a cycle of the first clock, the control logic asserts a power-gating signal, thereby returning the memory to the sleep mode. The frequency of the second clock is less than a frequency of the first clock.

### BRIEF DESCRIPTION OF THE DRAWINGS

Other aspects, features, and advantages of the present invention will become more filly apparent from the following detailed description, the appended claims, and the accompanying drawings in which like reference numerals identity similar or identical elements.

FIG. 1 shows a block diagram of a memory system in accordance with exemplary embodiments of the present invention;

FIG. 2 shows an exemplary method for applying power-gating to a memory employed by the system of FIG. 1;

FIG. 3 shows exemplary signals employed by the method of FIG. 2;

FIG. 4 shows an exemplary layout of a memory wrapper operating in accordance with embodiments of the present invention;

FIG. 5 shows another exemplary layout of a memory wrapper operating in accordance with embodiments of the present invention; and

FIG. 6 shows an exemplary method for applying transparent source bias employed by the system of FIG. 1; and

FIG. 7 shows an exemplary circuit diagram controlled by the process of FIG. 6.

### DETAILED DESCRIPTION

In accordance with embodiments of the present invention, a memory system power-gates a memory operating at a first clock. Control logic in the memory system activates, during a rising edge of a second clock, the memory from a sleep mode. The memory is accessed. After a cycle of the first clock, the control logic asserts a power-gating signal, thereby returning the memory to the sleep mode. The frequency of the second clock is less than a frequency of the first clock. Embodiments of the present invention trigger power-gating to reduce static memory power as operating frequency is reduced. Power-gating is part of a memory design solution, rather than being part of the system-on-chip (SoC) architecture, and, therefore, does not rely on changes to the SoC architecture to take advantage of power-gating signals. Embodiments extend the dynamic range at which memory power scales with frequency, resulting in an efficient memory power solution and high performance memory.

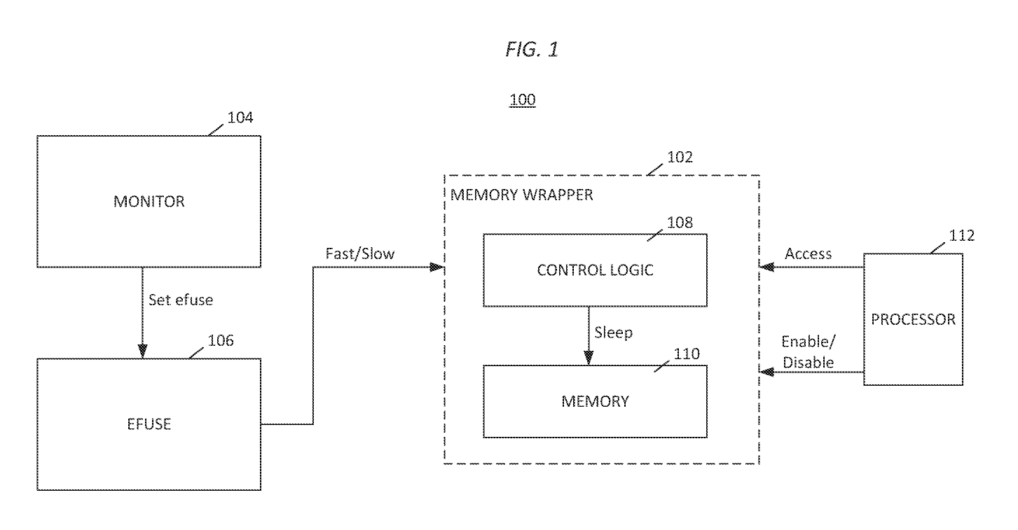

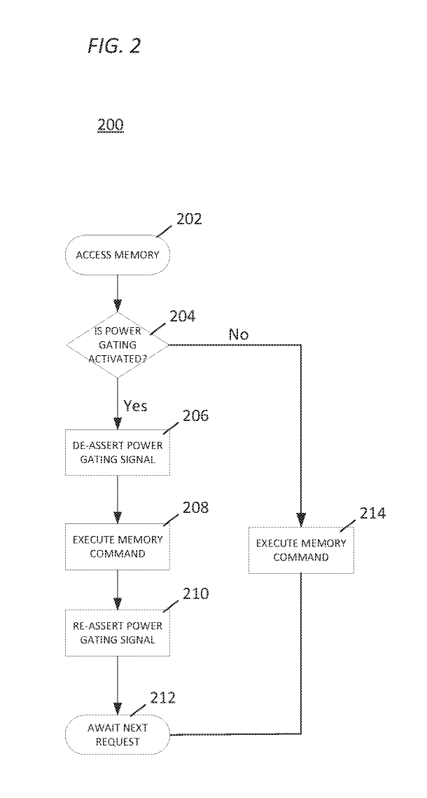

FIG. 1 shows a block diagram of an exemplary memory system 100. Exemplary memory system 100 might be implemented as a system on ship (SoC). As shown, memory system 100 comprises memory wrapper 102, monitor 104, and efuse controller 106. Memory wrapper 102 is coupled to processor 112 and comprises control logic 108 and memory 110. Memory wrapper 102 might be coupled to multiple processors, and each processor might be implemented as an application specific integrated circuit (ASIC) or as a system on chip (SoC). Memory 110 might be implemented as a dynamic random-access memory (DRAM), such as a double-data-rate three (DDR-3) DRAM, for off-chip storage of data. Signals Set efuse, Fast/Slow, Sleep, Access and Enable/Disable are described subsequently with respect to FIG. 2. For example, signal Fast might instruct control logic 108 to apply signal Sleep to memory 110, and signal Slow might prevent control logic 108 from applying signal Sleep. The Sleep signal might implement a variety of power reduction methods including placing memory 110 in a low-power sleep mode.

Chip process monitor 104 monitors process characteristics for an application or a chip when, for example, multiple memory modules are employed for memory 110. In other embodiments of the present invention, automatic test equipment (ATE) might read the output from process monitor 104 to determine, for example, whether the process meets a process threshold required to enable a sleep mode. For example, if chip process monitor 104 determines the process meets the threshold, it might instruct efuse controller 106 to apply signal Fast to memory wrapper 102. The signal Set eFuse is used to burn the signature of “Fast” into eFuse, where the eFuse signature is downloaded to control logic during chip power-up. In response, control logic 108 might provide signal Sleep to memory 110. Signal Sleep that is provided to memory 110 might also be gated by an external Enable/Disable signal provided by processor 112, described subsequently herein. Enable/Disable signal might be used by processor 112 to enable or disable a mode that adapts to process characteristics. Exemplary process thresholds are based on a variety of factors including application requirements and power reduction targets, in a memory comprising multiple memory groups, each group might have an associated threshold. Additionally, although FIG. 1 shows one memory wrapper 102, the invention is not so limited, and there may be multiple memory wrappers within memory system 100, each coupled to monitor 104, efuse controller 106, and processor 112.

FIG. 2 shows a flow diagram of power-gating process 200 employed by the exemplary memory system 100 of FIG. 1 in accordance with embodiments of the present invention. At step 202, a memory access request is received, for example, by memory wrapper 102. Processor 112 might access memory wrapper 102 through its Access signal, for example, to retrieve data. At step 204, a test determines whether a power-gating feature is activated. Power-gating might be defined as switching between relatively high and relatively low power consumption. For example, processor 112 might send an Enable signal to memory wrapper 102 to activate the power-gating feature. In some embodiments, processor 102 might send a Disable signal to memory wrapper 102 so that that the power-gating feature is deactivated. For example, power-gating might be disabled by processor 112 when memory 110 has a high access activity, as repeatedly going in and out of a low-power sleep mode consumes power. If the test at step 204 determines that the power-gating feature is activated, the power-gating signal (e.g., Sleep signal in FIG. 1) is de-asserted at step 206. Control logic 108 might de-assert the Sleep signal to memory 110 so that memory 110 is activated, thus memory 110 becomes ready for access. At step 208, the memory command is executed. For example, processor 112 might retrieve data from memory 110 or save data to memory 110. After the memory command is executed, control logic 108 re-asserts the power-gating signal at step 210, returning memory 110 to a low-power sleep mode. The process proceeds to step 212 and awaits the next memory request. If the test at step 204 determines that the power-gating feature is not activated, the process proceeds to step 214 where the memory command is executed, and then memory wrapper 102 awaits the next request at step 212.

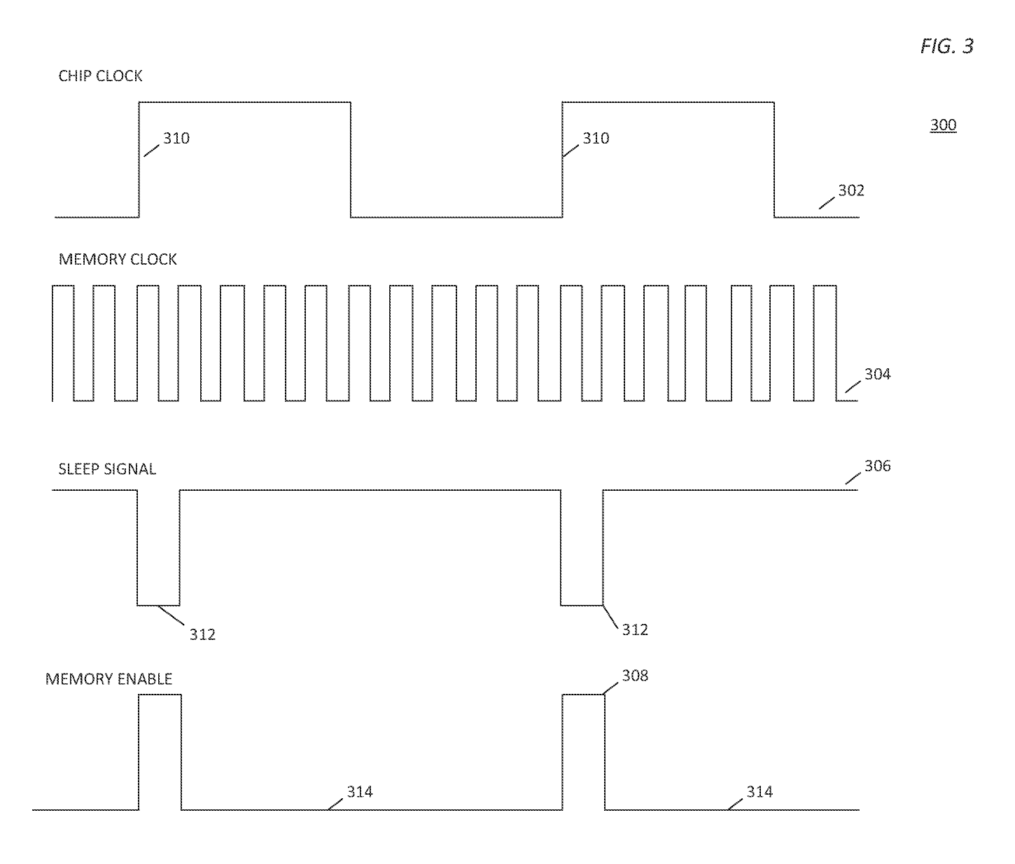

Some embodiments of the present invention employ a high-speed memory clock and much lower speed chip clock, for example, to implement power-gating process 200. For example, a chip clock in processor 112 (FIG. 1) might run at ⅕ or 1/10 the speed of a memory clock in memory 110, although the present invention is not so limited. Memory 110 might be accessed at step 202 using the rising edge of a chip clock, and then memory control logic 108 de-asserts the power-gating signal (e.g., Sleep) at step 206, thereby activating memory 110. To ensure that the power-gating signal is not continuously asserted and de-asserted at every clock cycle when memory 110 is in high-speed operation, the Enable/Disable signal might activate or deactivate the power-gating feature. The memory commands are executed at step 208 and 214, and the memory commands might be based on a high-speed memory clock. After the command is completed, control logic 108 re-asserts the Sleep signal sent to memory 110, putting memory 110 in a low-power sleep mode synchronized to the memory clock. Other embodiments might use an internal self-time signal of memory 110, instead of an external chip clock, to control assertion of the power-gating signal. Using the high-speed memory clock to execute memory commands might conserve power by enabling memory to remain in a low-power sleep mode for much of the duration of the chip clock cycle, as shown in the exemplary signal timing relationships 300 of FIG. 3.

FIG. 3 shows memory clock 304 (e.g., of memory 110) that has a frequency approximately ten times faster than chip clock 302 (e.g., of processor 112). Sleep signal 306 is de-asserted, as shown by the drops in amplitude 312, during the rising edges 310 of chip clock 302. Memory enable signal 308 illustrates how a memory might be activated when sleep signal 306 is de-asserted. A memory command might be executed during one cycle of memory clock 304, and then sleep signal 306 is re-asserted. In the embodiment illustrated by FIG. 3, the difference between the frequency of chip clock 302 and the frequency of memory clock 304 might allow a memory to remain in sleep mode 306 for approximately 90% more time than if a memory command was executed during a clock cycle. Some embodiments of the present invention intentionally choose a high speed memory instead of a slower memory, thereby reducing power consumption even though slower memories typically consume less power. Embodiments choose the high speed memory even though the slower memory is adequate for the application because less power is consumed by the high speed memory with power-gating as compared to the slower memory without power-gating.

Some embodiments of the present invention extend power-gating to memories of varying speeds, for example, to apply power-gating and conserve power at memory clock speeds that are marginally faster than chip clock speeds. Embodiments evaluate process corners, voltages, and temperatures (PVT) to selectively apply power-gating to memories, which might result in power efficient memories of all speeds. For example, at certain PVT, embodiments of the present invention allow memories to wake up from a low-power sleep mode and perform data access within one clock cycle. If a system determines that a memory's wake-up time plus data access time is greater than one clock cycle at a specific PVT, some embodiments might not use power gating at that PVT. Memory system 100 is an example of an embodiment which might determine whether to enable or disable a power-gating feature based on a predetermined process threshold, regardless of voltage and temperature. For example, a process threshold might be based on an application requirement or a power consumption target. Although memory system 100 shows one memory 110, the invention is not so limited, as there might be multiple memory groups associated with one or more memory wrappers, and each memory group might have an associated process threshold. Chip process monitor 104 might determine a process threshold for an application or a chip. If a memory module of memory 110 at least meets the threshold, efuse 106 might be set by signal Set efuse generated by monitor 104 to enable power-gating for each memory module of memory 110 that at least meets the threshold. Each memory module or memory 110 might have a different threshold, and therefore there might be multiple Enable signals corresponding to each memory or to a sub-group of memory.

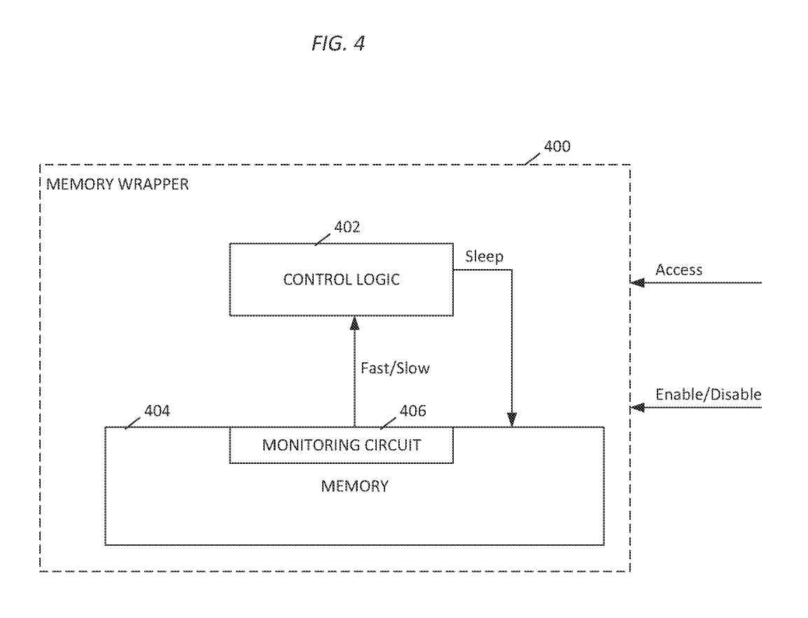

In another embodiment of the present invention, voltage and temperature are taken into account to determine whether power-gating is enabled. FIG. 4 shows exemplary memory wrapper 400 comprising control logic 402 and memory 404. Monitoring circuit 406 is employed by memory 404, so that, for example, each memory intended for power-gating might have a built-in power-gating timing circuit. Monitoring circuit 406 might mimic memory access time and power-gating enable (e.g., wake up) time. Power-gating for each memory is allowed if its monitoring circuit timing threshold is met, which occurs with a PVT value faster than a designed threshold. Each memory might make its own decision as to whether to allow power-gating based on a timing characteristic of the memory. A memory's timing characteristic might be based on any combination of process, voltage, or temperature. A threshold might be selected to ensure memory meets functional timing requirements at a specific PVT.

Some embodiments of the present invention that utilize a transparent source bias (TSB) circuit to reduce memory power leakage include a memory whose internal timing is set to a higher speed when TSB is disabled. Such embodiments might disable the TSB, for example, when power consumption is less of a priority than high speed operation. For example, internal timing of memory wrapper 102 might be set to a higher speed whenever TSB is disabled. Several conditions might be employed alone or in combination to enable/disable TSB with corresponding change in internal timing speed.

Monitor 104 might disable TSB when data for process and temperature information indicate that maximum power is not a priority, thereby allowing for an increase of the speed of memory 110. For example, TSB might be disabled when a process metric is below a predetermined threshold. Such process metric data might be taken at a wafer probe. The wafer probe process metric data is used to characterize the speed of the processed transistors to disable TSB for a processing metric below a certain value, where leakage reduction due to slow enough processing meets a maximum power specification without enabling TSB.

Alternatively, monitor 104 might also utilize an SoC temperature sensor to disable TSB when the temperature is below a predetermined temperature, thereby allowing processor 118 to access memory 110 at low temperatures without reaching low temperature timing closure limits. Other embodiments might also track current leakage of memory 110. Tracking of the current leakage might be internal or external to memory 110. Current leakage tracking combines both temperature and process corner effects. Current leakage tracking might be included with monitor 104, allowing TSB to be disabled when the tracked current drops below a predetermined threshold. This occurs because, in the silicon region, at low current and slow speed, TSB is disabled to make the speed requirement, but there is no concern with respect to the power budget. In contrast, at high current and high speed, TSB is on to make the power budget, without concern with respect to the high speed.

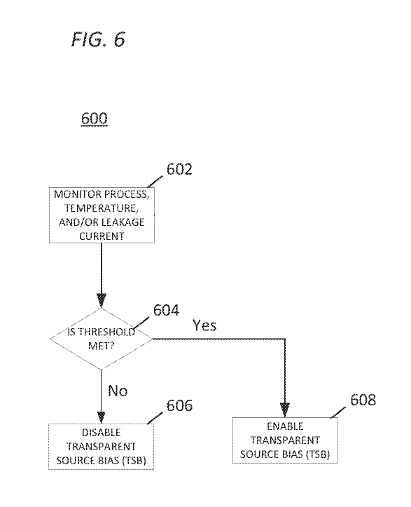

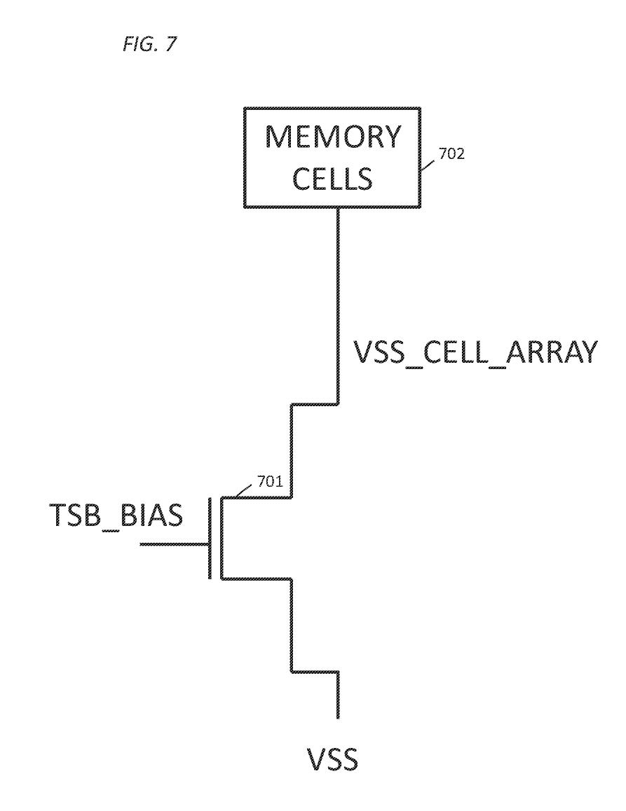

FIG. 6 shows a flow diagram of TSB process 600 employed by the exemplary memory system 100 of FIG. 1 in accordance with embodiments of the present invention. FIG. 7 shows an exemplary circuit diagram controlled by process 600 of FIG. 6. As shown in FIG. 7, transistor 701 is coupled between memory cells 702 and supply rail voltage VSS. Based on TSB_BIAS applied to transistor 701, memory cells 702 are either on fully, only when accessing memory cells 702, or partially off to reduce current to VSS when memory access is not active. For the example shown in FIG. 7, TSB_BIAS=VDD turns on memory cells fully for accessing memory, and VSS<TSB_BIAS<VDD reduces current to VSS when memory access is not active.

Returning to FIG. 6, at step 602, at least one of a process, a temperature, and a leakage current of the memory is monitored. A test at step 604 determines whether the at least one monitored process, temperature and leakage current of the memory reach a corresponding threshold. The threshold might be set on a power budget of the memory. If the test at 604 determines that the threshold is not met, the process proceeds to step 606 where TSB is disabled (e.g., via TSB_BIAS=VDD of FIG. 7), allowing the memory to operate at a relatively high speed. If the test at step 604 determines that the threshold is met, the process proceeds to step 608 where TSB is enabled (e.g., via VSS<TSB_BIAS<VDD of FIG. 7), thereby operating the memory at a relatively low speed.

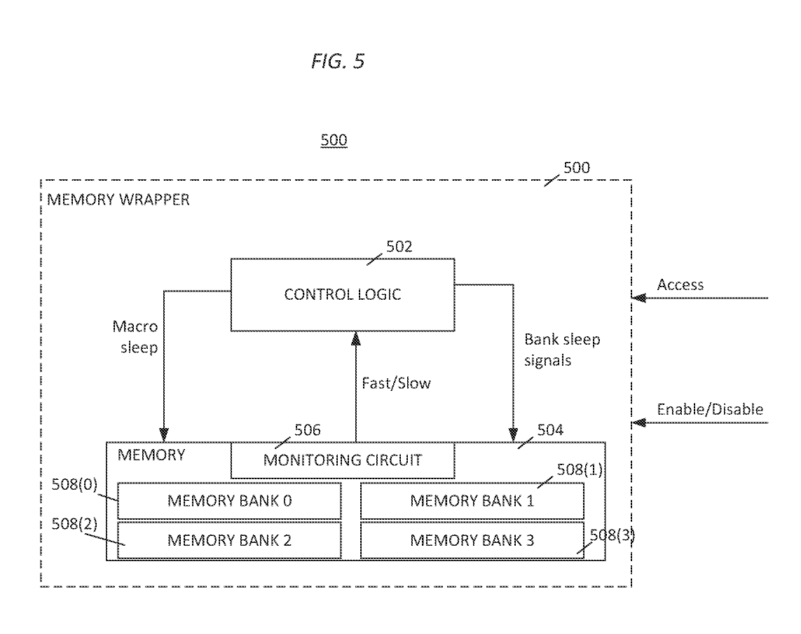

While the present invention is described with respect to a single memory in a memory wrapper, the present invention is not so limited. For example, power-gating might be implemented internally to the memory, and therefore without a memory wrapper. Additionally, power-gating might be applied to a memory bank level, such as shown in exemplary multibank memory 504 of FIG. 5. FIG. 5 shows four memory banks 508(0)-508(3), although multibank memory 504 is not so limited. Multibank memory 504 might implement power-gating internally or using memory wrapper 500. Using memory wrapper 500, control logic 502 might send an individual Bank Sleep signal to each memory bank 508(0)-508(3) to put the corresponding memory bank 508 in a low-power sleep mode. Control logic 502 might also send a Macro Sleep signal to multibank memory 504 to put all memory banks 508(0)-508(3) in a low-power sleep mode. Dividing multibank memory 504 into memory banks 508(0)-508(3) might allow application of power gating to individual controllable parts (e.g., one or more memory banks 508(0)-508(3)) instead of the whole multibank memory 504, thereby allowing inactive parts of multibank memory 504 to be power-gated even while other active parts of memory are accessed.

The present invention might allow for the following advantages over previously known designs of memory power management systems. The present invention triggers power-gating to reduce static memory power as operating frequency is reduced. Power-gating is part of a memory design solution, rather than being part of the system-on-chip (SoC) architecture, and, therefore, does not rely on changes to the SoC architecture to take advantage of power-gating signals. The present invention extends the dynamic range at which memory power scales with frequency, resulting in an efficient memory power solution and high performance memory.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

While the exemplary embodiments of the present invention have been described with respect to processing in hardware, including possible implementation as a single integrated circuit, a multi-chip module, a single card, or a multi-card circuit pack, the present invention is not so limited. As would be apparent to one skilled in the art, various functions of hardware may also be implemented in a software program. Such software may be implemented as steps performed by, for example, a digital signal processor, micro-controller, or general purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the invention. The present invention can also be embodied in the form of program code, for example, whether stored in a non-transitory machine-readable storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. Signals and corresponding nodes or ports may be referred to by the same name and are interchangeable for purposes here. It will be further understood that various changes in the details, materials, and arrangements of the parts which have been described and illustrated in order to explain the nature of this invention may be made by those skilled in the art without departing from the scope of the invention as expressed in the following claims.

It will be further understood that various changes in the details, materials, and arrangements of the parts which have been described and illustrated in order to explain the nature of this invention may be made by those skilled in the art without departing from the scope of the invention as expressed in the following claims.

We claim:

1. A method of power-gating a memory operating at a first clock, the method comprising:
activating, during a rising edge of a second clock, the memory from a sleep mode;
accessing the memory; and
after a cycle of the first clock, asserting a power-gating signal, thereby returning the memory to the sleep mode,
wherein a frequency of the second clock is less than a frequency of the first clock.

2. The method of claim 1, further comprising:
selecting a fast memory with a power-gating feature instead of a slow memory without the power-gating feature, thereby reducing a power consumption value.

3. The method of claim 1, wherein the second clock is a chip clock.

4. The method of claim 1, wherein the second clock is a self-time signal of the memory.

5. The method of claim 1, further comprising:
determining a timing threshold;
determining whether a timing characteristic of the one or more memory groups of the memory reaches the timing threshold; and
applying power-gating to selected ones of the one or more memories with the corresponding tuning characteristic having reached the timing threshold.

6. The method of claim 5, wherein the timing characteristic is based on a process characteristic.

7. The method of claim 5, wherein the timing characteristic is based on a voltage.

8. The method of claim 5, wherein the timing characteristic is based on a temperature.

9. The method of claim 5, therein the timing characteristic is based on at least two of the process characteristic, the voltage, and the temperature.

10. The method as recited in claim 1, wherein the method is implemented as steps executed by a system-on-chip (SoC).

11. A memory system, the system comprising:
one or more memories operating at a first clock;
a processor operating at a second clock and adapted to access the one or more memories;
a control logic coupled to the one or more memories and the processor, adapted to:
activate, during a rising edge of a second clock, the one or more memories from a sleep mode; and
after a cycle of the first clock, assert a power-gating signal, thereby returning the one or more memories to the sleep mode,
wherein a frequency of the second clock is less than a frequency of the first clock.

12. The memory system of claim 11, wherein the second clock is a chip clock.

13. The memory system of claim 11, wherein the second clock is a self-time signal of the one or more memories.

14. The memory system of claim 11, wherein the memory system is a system-on-chip (SoC).

15. The memory system of claim 11, wherein the processor is further adapted to:
select a fast memory with a power-gating feature instead of a slow memory without the power-gating feature, thereby reducing a power consumption value.
